(19) United States
(12) Patent Application Publication
(10) Pub. No.: US 2012/0210988 A1
(43) Pub. Date: Aug. 23, 2012

(54) VARIABLE GAS SUBSTITUTION FOR DUEL FUEL ENGINE AND METHOD

(75) Inventor: Martin WILLI, Dunlap, IL (US)

(73) Assignee: CATERPILLAR INC., PEORIA, IL (US)

(21) Appl. No.: 13/031,845

(22) Filed: Feb. 22, 2011

(51) Int. Cl. F02D 19/08; F02D 19/10

(52) U.S. Cl. 123/575

(57) ABSTRACT

A system having an internal combustion engine connected to a driven device includes primary and secondary fuel supplies. A primary fuel supply sensor is configured to provide a primary fuel supply signal indicative of a rate of supply of a primary fuel to the engine through the primary fuel supply. A secondary fuel supply sensor is configured to provide a secondary fuel supply signal indicative of a rate of supply of a secondary fuel to the engine through the secondary fuel supply. A power output sensor measures a parameter indicative of a power output of the driven device and provides a power output signal. An electronic controller receives the primary and secondary fuel supply signals and the power output signal, and determines a characteristic of the secondary fuel based on the primary and secondary fuel supply signals and the power output signal.

### TECHNICAL FIELD

This patent disclosure relates generally to internal combustion engines and, more particularly, to engines configured to operate with more than one type of fuel such as diesel and natural gas.

### BACKGROUND

Dual fuel engines are known for various applications, such as generator sets, engine-driven compressors, engine driven pumps, machine, off-highway trucks and others. Typically, such engines are stationary and operate in the field. The operation of such engines by substitution of a certain amount of heavy fuel, such as diesel, with a lighter fuel, such as natural gas, biogas, liquid petroleum gas (LPG) or other types of fuel that may be more readily available and cost effective, makes them more effective to operate.

Nevertheless, it is often the case that the quality of the secondary fuel available in certain areas is not consistent. For example, when the secondary fuel is biogas generated onsite at an area, or even LPG or natural gas purchased from local sources, the fuel heating value and/or the methane number of these fuels is certain to vary over time or for different batches of fuel purchased. Such changes in the methane number or fuel heating value require various changes to the operation of the engine, such as diesel fuel injection amounts, injection timing, and the like, so that efficient engine is maintained.

In the past, various methods have been employed by engine operators and engine manufacturers to address the variability of fuel quality that is used in the field. Commonly, a sample of a fuel batch will be acquired, for example, on a monthly basis for continuous fuel sources, such as biogas, or from each batch of fuel purchased, for analysis. A typical analysis may include the direct measurement of various fuel constituents, which is an expensive and difficult process. Other existing approaches include the use of gas cleanup systems that remove heavier hydrocarbons in the fuel, which is an expensive process, or use in-situ gas chromatography to determine gas composition. This type of process requires use of expensive and sensitive equipment in the field, periodic calibration of the equipment from specialized personnel, and the presence of an operator to analyze the results and perform adjustments to the engine operation on a continuous basis. All these and other factors add cost and complexity to the operation of the field engine.

### SUMMARY

The disclosure describes, in one aspect, a system that includes an internal combustion engine connected to a driven device. The system has a primary fuel supply connected to the engine and including a primary fuel supply sensor. The primary fuel supply sensor is configured to provide a primary fuel supply signal indicative of a rate of supply of a primary fuel to the engine through the primary fuel supply. A secondary fuel supply is connected to the engine and includes a secondary fuel supply sensor. The secondary fuel supply sensor is configured to provide a secondary fuel supply signal indicative of a rate of supply of a secondary fuel to the engine through the secondary fuel supply. A power output is connected to the driven device and includes a power output sensor. The power output sensor is configured to measure at least one parameter indicative of a power output of the driven device and provide a power output signal. An electronic controller is operably associated with the engine and the driven component. The electronic controller is disposed to receive the primary and secondary fuel supply signals and the power output signal and determine at least one characteristic of the secondary fuel based on the primary and secondary fuel supply signals and the power output signal.

In another aspect, the disclosure describes a method for determining at least one property of a secondary fuel used to substitute a portion of a primary fuel during operation of an internal combustion engine. In one embodiment, the engine is connected to a generator. The method includes operating the engine and the generator at a predetermined condition. A flow of primary fuel having a known property is provided to the engine. The flow of the primary fuel, the output of the generator, and a flow of the secondary fuel are measured. At least one property of the secondary fuel is determined based on the flow of primary fuel and the output of the generator.

In yet another aspect, the disclosure describes a dual fuel system for an engine having an engine output shaft connected to a power generator providing electrical power to a power grid. The dual fuel system includes a primary fuel supply connected to the engine and a primary fuel supply sensor configured to provide a primary fuel supply signal indicative of a rate of supply of a primary fuel to the engine through the primary fuel supply. A secondary fuel supply is connected to the engine and includes a secondary fuel supply sensor configured to provide a secondary fuel supply signal indicative of a rate of supply of a secondary fuel to the engine through the secondary fuel supply. A power output sensor is connected to a power output of the power generator and configured to measure the electrical power provided to the power grid and provide a power output signal. An electronic controller is operably associated with the engine and the power generator. The electronic controller is disposed to receive the primary and secondary fuel supply signals and the power output signal. The electronic controller is further configured to determine at least one characteristic of the secondary fuel based on the primary and secondary fuel supply signals and the power output signal.

### BRIEF DESCRIPTION OF THE DRAWINGS

FIG. 1 is a block diagram of an internal combustion engine configured to operate using two fuel supplies in accordance with the disclosure.

FIG. 2 is a block diagram of an engine controller in accordance with the disclosure.

FIG. 3 is a flowchart for a method of operating an internal combustion engine having dual fuel capability in accordance with the disclosure.

### DETAILED DESCRIPTION

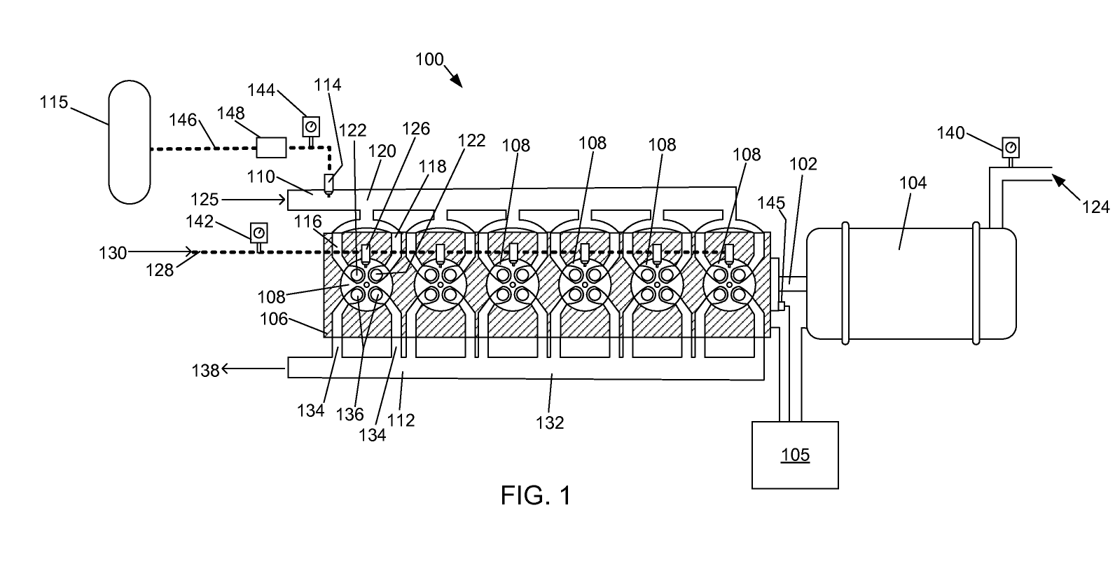

FIG. 1 is a block diagram representation of an internal combustion engine 100 in accordance with the disclosure. As shown, the engine 100 is a stationary engine that is part of a generator set. Alternatively, the engine 100 may be part of a machine or off-highway truck and be connected to an electrical generator that is part of a hybrid-electric drive system, a fluid pump that is part of a hydrostatic drive system, and the like. The engine 100 has an output shaft 102 connected to a generator 104. During operation, the engine 100 may operate at a nearly constant engine speed but at a varying load depending on the electrical power or current output of the generator 104. A controller 105 may be operably associated with various engine and/or generator systems. The controller 105 in the illustrated embodiment includes operable connections to various sensors and systems of the engine 100 and generator 104, and is configured to receive information on the operating parameters thereof as well as send commands to various actuators and systems through the connections.

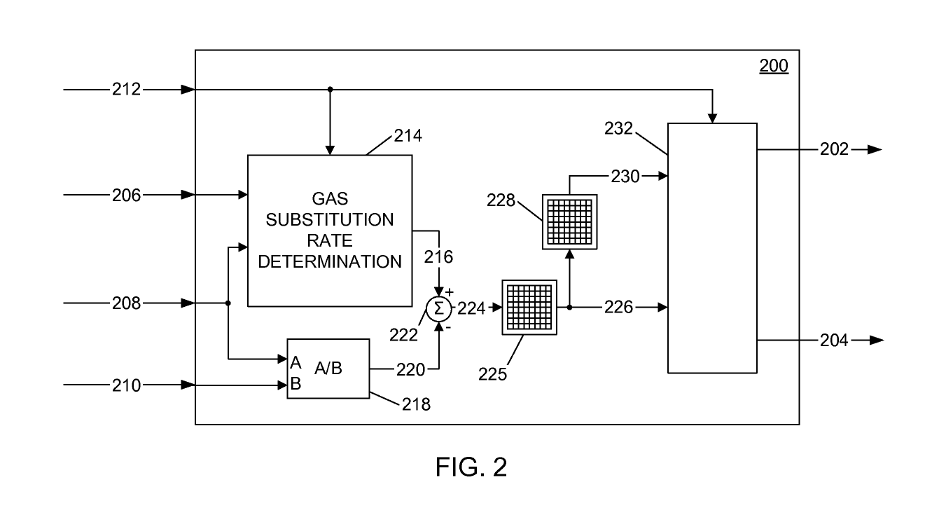

The controller 105 may be a single controller or may include more than one controller disposed to control various functions and/or features of the system. For example, a master controller, used to control the overall operation and function of the generator set may be cooperatively implemented with an engine controller used to control the engine 100. In this embodiment, the term “controller” is meant to include one, two, or more controllers that may be associated with the engine 100 and that may cooperate in controlling various functions and operations of the engine 100 and generator 104. The functionality of the controller 105, while shown conceptually in FIG. 2 to include various discrete functions for illustrative purposes only, may be implemented in hardware and/or software without regard to the discrete functionality shown. Accordingly, various interfaces of the controller are described relative to components of the generator set shown in the block diagram of FIG. 1. Such interfaces are not intended to limit the type and number of components that are connected, nor the number of controllers that are described.

Accordingly, the controller 105 in the illustrated embodiment is configured to receive information indicative of various operating parameters of the engine 100 and to control various operating parameters of the engine 100, such as fuel injection timing, allowable or desired fuel substitution rates depending on the operating point of the engine 100, and others. The engine 100 may include various components and systems, such as lubrication and electrical systems, which have been omitted from FIG. 1 for simplicity. Relevant to the present disclosure, the engine 100 includes a crankcase 106 having one or more combustion cylinders 108 formed therein. Although six cylinders 108 are shown in an inline configuration, any other number of cylinders arranged in different configurations, such as a “V” configuration, may be used.

Each cylinder 108 includes a reciprocable piston defining a combustion chamber that is connectable to an intake manifold 110 and an exhaust manifold 112. Each cylinder 108 includes a direct-injection diesel injector 126. The diesel injectors 126 are connected to a source of pressurized diesel fuel, which provides fuel to each injector 126 via a diesel fuel line 128. Each injector 126 is configured to inject a predetermined amount of diesel fuel 130 into each cylinder 108 in response to an appropriate command from the controller 105 during engine operation. For example, the controller 105 may be configured to receive timing information from the engine 100, which is used to determine the appropriate injection timing for each combustion cylinder 108.

The engine 100 further includes a secondary fuel injector 114 disposed to inject a predetermined amount of fuel into the intake manifold 110. In the illustrated embodiment, for example, the secondary fuel injector 114 is a gas fuel injector 114 that is operably connected to a supply of gaseous fuel or reservoir 115, which may be a tank reservoir or may alternatively be a pressure regulated supply from a field source, such as biogas from a land fill, natural gas from an oil well and the like. The gas fuel injector 114 operates to deliver a predetermined amount of gaseous or another secondary fuel into the intake manifold 110. The fuel delivered mixes with incoming air 125 to form an air/fuel mixture that is admitted into the cylinders 108 via intake valves 122.

During operation, an air/fuel mixture from the intake manifold 110 is admitted into each cylinder 108. Diesel fuel is injected into each cylinder 108 at the appropriate time and duration during engine operation to provide a richer air/fuel mixture than what is already present in the cylinder 108. Compression of this mixture within the cylinder 108 causes auto-ignition of the diesel fuel found therein, which initiates combustion of all combustible fuels found the in the cylinder. This includes the diesel fuel as well as the secondary fuel that was previously delivered to the intake manifold by the secondary fuel injector 114.

The auto-ignition of diesel fuel provided by each injector 126 causes the combustion of an air/fuel mixture present in a compressed state in each cylinder 108. Each cylinder 108 is configured to selectively receive air from the intake manifold 110, which may be at or below atmospheric pressure for a naturally aspirated engine, or may alternatively be under positive gage pressure in a turbocharged or supercharged engine. In the illustrated embodiment, the engine 100 may further include a turbocharger (not shown) that is fluidly connected in the known configuration between the intake and exhaust manifolds 110 and 112.

During operation, air from the intake manifold 110 is provided to each cylinder 108 via, respectively, first and second intake ports 116 and 118. The first and second intake ports 116 and 118 of each cylinder 108 may be directly connected to an intake plenum volume 120 of the intake manifold 110 or may alternatively be branches of a combined intake port (not shown) that is fluidly open to the intake plenum volume 120. A first intake valve 122 is disposed to fluidly isolate the cylinder 108 from the first intake port 116, and a second intake valve 122 is similarly disposed to fluidly isolate the cylinder 108 from the second intake port 118. When the first and second intake valves 122 are closed, such as during combustion of the air/fuel mixture in the cylinder 108, fluid communication between each respective cylinder 108 and the intake manifold 110 is blocked. Similarly, at least partial opening of either the first and/or second intake valve(s) 122 permits the fluid communication of the cylinder 108 with the intake plenum volume 120 such that air 125 may enter the cylinder 108. The combustion of the air/fuel mixture in the cylinder 108 produces power, which is transferred as torque to the output shaft 102 to drive the generator 104. The generator 104 is configured to provide electrical power through an output node 124. Although two leads are shown in the output node 124, any other appropriate arrangement for electrical power production and distribution, such as multiphase outputs having more than two leads are contemplated.

Exhaust gas remaining after the combustion of fuel from each injector 126 with air from the first and second intake ports 122 within each cylinder 108 is evacuated and collected in the exhaust manifold 112. In the illustrated embodiment, each cylinder 108 is fluidly connectable to an exhaust plenum volume 132 via two exhaust ports 134. Each exhaust port 134 is fluidly isolatable from the cylinder 108 by a corresponding exhaust valve 136. The exhaust gas 138 collected is removed from the exhaust manifold 112. Although two exhaust valves 136 are shown corresponding to each cylinder 108, a single exhaust valve disposed in a single exhaust port per cylinder 108 may be used.

The engine 100 and related generator 104 system includes various sensors that are relevant to the present disclosure. More particularly, an electrical power sensor 140, which is generically illustrated in FIG. 1, is associated with the output node 124 and configured to measure a parameter indicative of an electrical power output of the generator 104 such as electrical voltage and/or current. Signals indicative of the electrical power measured by the sensor 140 are provided to the controller 105. A diesel flow sensor 142 is associated with the diesel fuel line 128 and configured to measure one or more parameters indicative of a flow rate of diesel fuel that is provide to the injectors 126 during operation of the engine 100. Alternatively, a determination of the total fuel flow rate of diesel fuel may be carried out within the electronic controller 105 based on an aggregate of known diesel injection amounts that are provided by each injection event. In one alternative embodiment, the basis for fuel delivery determination may be made on the basis of each engine stroke or each fuel injection event rather than in the aggregate. When the diesel flow sensor 142 is used, the information or signals indicative of the flow rate of diesel fuel provided to the engine 100 is communicated either directly or indirectly to the controller 105. Additional sensors may be used, such as airflow, air pressure and/or oxygen concentration sensors (not shown) configured to measure parameters of the incoming airflow 125. In the illustrated embodiment, an engine speed sensor 145 is connected to the controller 105 and configured to provide a signal indicative of the speed of the engine, for example, as measured at the shaft 102.

A secondary fuel flow sensor 144 is associated with a secondary fuel supply line 146 at a location downstream from a secondary fuel flow control valve 148. In an embodiment where the secondary fuel is a gas as shown, for example, in FIG. 1, the control valve 148 may be operably associated with the controller 105 and configured to meter the flow of fuel from the reservoir 115 to the injector 114 in response to appropriate signals from the electronic controller 105. The secondary fuel flow sensor 144 may be located anywhere along the fuel line 146. In the illustrated embodiment, the fuel flow sensor 144 is located downstream of the control valve 148. The secondary fuel flow sensor 144 may be any appropriate type of digital or analog output sensor that is configured to provide a signal to the electronic controller 105 that is indicative of the mass flow or volume flow rate of gaseous fluid passing through the injector 114 during engine operation.

A block diagram for a controller 200 is shown in FIG. 2. The controller 200 may be part of a larger control scheme for controlling and monitoring the operation of the engine 100 (FIG. 1). The controller 200 may be further integrated with and be operating within the electronic controller 105 (FIG. 1) such that inputs and outputs of the controller 200 are signals present within the electronic controller 105.

The controller 200 operates to provide an allowable substitution rate 202 and a desired diesel fuel injection timing 204 during operation based on various inputs. In the illustrated embodiment, the controller 200 is configured to receive an electric power signal 206, a primary fuel or diesel fuel flow rate 208 and a secondary fuel or gas fuel flow rate 210. The electric power signal 206 may be a signal indicative of a power output of a generator connected to an engine, such as the generator 104 connected to engine 100 as shown in FIG. 1. The electric power signal 206 may be provided by, or be based on, a signal provided to the controller 105 by the electrical power sensor 140 connected to the output 124.

The diesel fuel flow rate 208 may be provided by an appropriate sensor disposed to measure, in real time, the flow rate of liquid fuel provided to the engine, such as the sensor 142 shown in FIG. 1. Alternatively, the diesel fuel flow rate 208 may be a signal calculated as an aggregate fuel being commanded by a fuel control module (not shown) that operates the injectors 126 (FIG. 1). Similarly, the gas fuel flow rate 210 may be provided by an appropriate sensor, such as the sensor 144 (FIG. 1), or may alternatively be determined analytically from a fuel command module (not shown) operating the activate the injector 114 (FIG. 1) to deliver a predetermined amount of fuel to the engine.

In the illustrated embodiment, the controller 200 is further disposed to receive an enable signal 212. The enable signal 212 may simply be a discrete value of zero or one, where zero may indicate normal operation and where a value of 1 indicates that the controller 200 is in a calibration mode, as will be hereinafter described.

In the disclosed system, the controller 200 is advantageously configured to adjust certain engine operating parameters such that variations in the quality and characteristics of the secondary fuel, in this case the gaseous fuel, are compensated for over time. More specifically, when the enable signal 212 indicates that the controller 200 is in a calibration mode, the engine may be put into a predetermined operating condition such that a desired or allowed substitution rate of the primary fuel by the second fuel may be empirically determined. This calibration may be carried out periodically, such as once a week or any time a new batch of fuel is procured to ensure that the engine operates at an optimum level. Moreover, the adjustment of the appropriate operating parameters can be made automatically by the controller 200 without the need for specialized fuel analyzer equipment and manual adjustment of engine operating parameters.

More specifically, when the controller 200 receives the enable signal 212, the engine is caused to operate at a predetermined engine speed and load operating point by the appropriate section of the engine controller (not shown). The engine speed may be measured, for example, by the engine speed sensor 145 (FIG. 1), and the load may be measured by the electrical power sensor 140. The predetermined operating point may be a single operating point that can be run when the generator is offline, or may alternatively be one of many predetermined points that is selected to be as close as possible to the operating point of the engine at the time the calibration process is initiated. In one embodiment, the controller 200 may be configured to automatically initiate a calibration when the engine has been operating at a constant point for a predetermined period. In this embodiment, the calibration may be terminated if the engine is required to alter its operating condition while the calibration is carried out.

In the simplified embodiment shown in FIG. 2, the controller 200 includes a gas substitution rate determination 214. The gas substitution rate determination 214 is configured to compare the electric power signal 206 with the diesel fuel flow rate 208 to infer a theoretical gas fuel flow rate, which together with the known diesel fuel flow rate provides an estimated gas substitution rate 216. In one embodiment, the gas substitution rate determination 214 may include a calculation that is based on an energy balance of the engine/generator system as a whole. In other words, given the power output of the system (for example, the electrical power output of the generator) and given one of the two energy inputs (such as the enthalpy of combustion of the incoming diesel fuel), the determination of the additional energy input that is required (such as the enthalpy of combustion of the incoming gas fuel) may be estimated. This estimation may be further based on known efficiency and energy conversion rates of the system.

The diesel fuel flow rate 208 is also provided to one input node of a divider 218. The second input node of the divider 218 receives the gas fuel flow rate 210 so that the divider can perform a calculation to determine an actual or measured gas substitution rate 220, which in the illustrated embodiment is expressed as a ratio between the diesel fuel flow rate 208 and the gas fuel flow rate 210.

The estimated gas substitution rate 216 is compared to the measured gas substitution rate 220 at a comparator 222 to provide a substitution rate deviation 224. In the illustrated embodiment, the comparator 222 calculates the rate deviation 224 as a difference between the estimated and measured gas substitution rates 216 and 220. The rate deviation 224 may be positive or negative depending on the secondary fuel properties determined in a previous calibration as compared to the actual properties of the secondary fuel being provided to the engine during a subsequent calibration.

The rate deviation 224 is provided to a gas heating value determination function 225. The gas heating value determination function 225, which in the illustrated embodiment includes a lookup table or one-dimensional lookup function, is configured to determine a corrected gas heating value 226, which is based on a correction to a previously determined gas heating value based on the rate deviation 224. The corrected gas heating value 226 substantially matches the actual heating value of the gas currently supplied to the engine.

The corrected gas heating value 226 is also provided to a fuel heating value to methane number correlation table 228. The correlation table 228 provides the methane number 230 of the gas based on a predetermined correlation or relationship. The methane number 230 and the corrected gas heating value 226 are provided to a dual fuel control 232. The dual fuel control 232 is configured to adjust and provide updated parameters for the allowable substitution rate 202 and the diesel injection timing 204 based on the corrected gas heating value 226 and the revised methane number 230. In one embodiment, the dual fuel control 232 includes lookup tables and other functions containing tabulated engine operating parameters for the allowable substitution rate and diesel injection timing, which are provided to other engine controller functions that determine the appropriate substitution rate and injection timing based on the specific engine operating conditions such as engine speed and load.

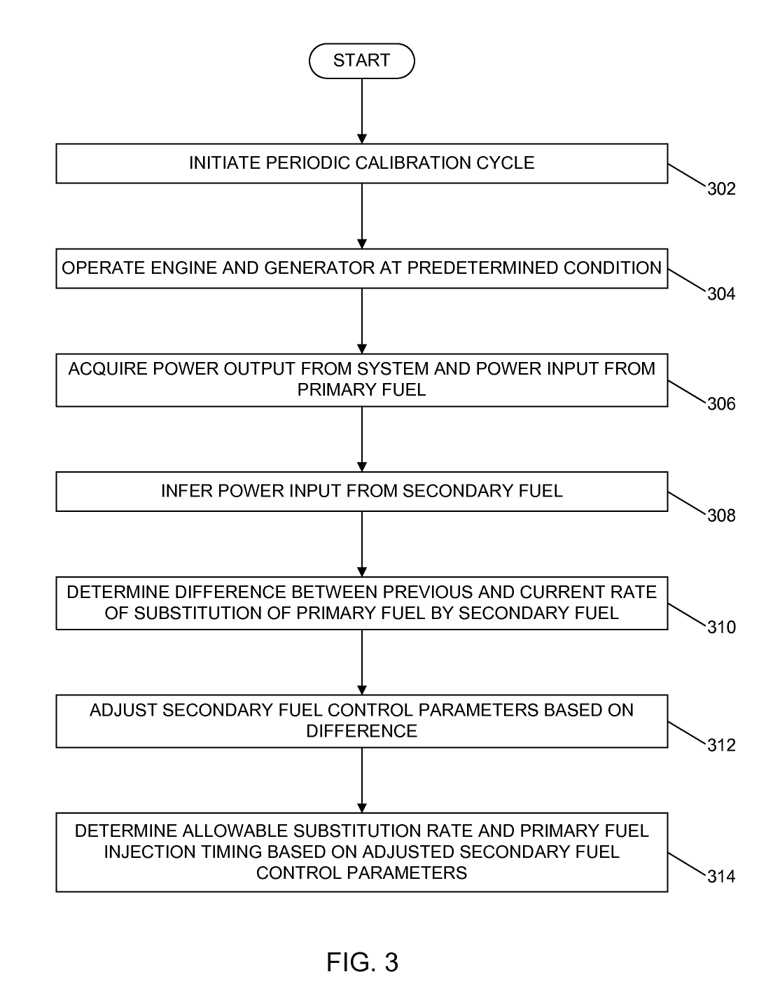

A flowchart for a method of operating a dual fuel engine is shown in FIG. 3. The method is suitable for any engine operating with two or more fuels. The method can provide a periodic adjustment of fuel substitution parameters based on the quality of at least one secondary fuel of the engine, automatically, and without the need for external experimental determination of fuel quality and subsequent manual adjustment of engine operating parameters. As can be appreciated, the capability of automatically determining the secondary fuel characteristics without the need of external testing to determine those characteristics is a considerable improvement over the processes presently in use. By automatically performing periodic determination of fuel characteristics and adjustment of engine operation, the engine may be operated at a lower cost and at a higher efficiency.

A calibration process is initiated at 302. The initiation of the calibration process may be accomplished in a variety of conditions that are expected to produce a measurable shift in the combustion properties of the secondary fuel. For example, if the source of the secondary fuel is a natural gas flow provided by a drilling or refinery operation, a calibration of the properties of the secondary fuel may be performed periodically, such as weekly, to ensure that potential variations in the secondary fuel are accounted for. Alternatively, if the secondary fuel is furnished by commercial sources in batches, the calibration may be conducted once for each new batch of fuel provided to the engine.

When the engine is in a calibration mode, the engine and generator are operated at a predetermined condition at 304. The predetermined condition may be a single operating point or it may be one of a plurality of operating points that is appropriately selected. In the case where a single operating point is used, the generator may be temporarily taken off the electric grid it supplies power to such that a preselected nominal power output may be provided. Alternatively, the generator may remain connected to the grid and a preselected power that is the closest to a then present power consumption of the grid may be selected for conducting the calibration.

While the engine and generator are operating at the predetermined condition, a power output from the engine/generator system and a power input to the system from the primary fuel are acquired in the form of data or other signals from sensors at 306. An electronic controller operably associated with the engine/generator system may be useful for this acquisition, which may include measurements, calculations, or other methods for quantifying the power input to the engine/generator system. For example, the chemical or combustion energy included in the inflow of the primary fuel to the engine, and the electrical power at the output of the generator may be used. The electronic controller performing these determinations may further include various constants or other parameters indicative of the energy conversion efficiency of the various relevant components and systems, as well as predetermined constants indicative of the combustion properties of the primary fuel, which are presumed to be known and to remain substantially unchanged over time.

A power input of the secondary fuel is inferred at 308 based on the power input from the primary fuel and the power output of the system. In the illustrated embodiment, the primary fuel is diesel fuel having known properties and the secondary fuel is natural gas. By measuring the mass flow or volumetric flow rate of the secondary fuel, an energy balance relation between the energy input to the engine/generator system from the two fuel sources and the power output of the system may be used to determine the energy content of the secondary fuel. In one embodiment, this energy balance relationship may be arranged as a lookup table, a model, or any other type of calculation or interpolation that correlates the applicable parameters, such as power output of the generator, diesel fuel rate and gas flow rate, to provide a gas heating value and/or a methane number of the gas.

Having determined the power input from the secondary fuel at 308, a difference between a previous and a current or measured substitution rate of the primary fuel by the secondary fuel is determined at 310. This determination may be a change in operating parameters of the engine in which a desired or allowed rate or ratio of substitution of the primary fuel by the secondary fuel is determined and stored in the electronic controller controlling the engine. In one embodiment, the allowed substitution rate is used by the controller to adjust the primary and secondary fuel supplies when operating conditions of the engine change such as when the electrical load of the generator changes in response to changes in consumption. Moreover, parameters used by the electronic controller to qualify use of the secondary fuel are adjusted at 312 to reflect the most up to date information about the qualities of the secondary fuel based on the difference determined at 310.

Having determined the appropriate parameters of the secondary fuel, the allowable substitution rate and primary fuel injection timing are determined at 314. In one embodiment, this determination is based on the adjusted control parameters of the secondary fuel that were adjusted at 312. Other control parameters of the engine may be adjusted once the properties of the secondary fuel are known. For example, in addition to adjustments to the injection timing of the primary fuel, the engine may be operated with variable valve timing, with variable intake and/or exhaust pressure and so forth depending on the hardware capabilities of the various engine components and systems such that engine operation may be optimized.

### INDUSTRIAL APPLICABILITY

This disclosure generally relates to dual fuel internal combustion engines. The embodiments described herein specifically relative to engines operating on natural gas, liquefied petroleum gas (LPG), biogas, or any other combustible fuel, and connected to electrical generators for the generation of electrical power, but any other type of engine may be used. Additional application examples contemplated are engines that are used to drive machines and/or other off-highway trucks that are connected to generators that are part of hybrid-electric drive systems, fluid pumps that are part of hydrostatic drive systems, and the like. Accordingly, although a stationary engine application is described, the systems and methods disclosed herein are applicable to engines installed in large equipment, such as locomotive or marine applications, as well as engines installed in vehicles, such as in the trucking or automotive industries. Moreover, although a generator is disclosed in the embodiment described above, other applications of engines may be used. For example, an engine used to operate a gas compressor may be operated in the above-described fashion whereby the power output of the system may be determined based on an increase in enthalpy of the working gas of the compressor by, for example, measurements of the pressure and density of the gas both upstream and downstream of the compressor. Additional examples include fluid pumps in which measurement of the pressure and flow rate of hydraulic fluid through the pump can be an indication of the power output of the pump. In an alternate embodiment, the calibration of the engine may not require operation of the engine at a predetermined point. Although such operation is advantageous, the measurement of the power inputs and outputs of the engine system in real time enables the constant determination of the secondary fuel quality in real time.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

1. A system including an internal combustion engine connected to a driven device, comprising:
a primary fuel supply connected to the engine and including a primary fuel supply sensor, the primary fuel supply sensor configured to provide a primary fuel supply signal indicative of a rate of supply of a primary fuel to the engine through the primary fuel supply;
a secondary fuel supply connected to the engine and including a secondary fuel supply sensor, the secondary fuel supply sensor configured to provide a secondary fuel supply signal indicative of a rate of supply of a secondary fuel to the engine through the secondary fuel supply;
a power output connected to the driven device and including a power output sensor, the power output sensor configured to measure at least one parameter indicative of a power output of the driven device and to provide a power output signal;
an electronic controller operably associated with the engine and the driven device, the electronic controller disposed to receive the primary and secondary fuel supply signals and the power output signal,
wherein the electronic controller is configured to determine at least one characteristic of the secondary fuel based on the primary and secondary fuel supply signals and the power output signal.

2. The system of claim 1, wherein the electronic controller is configured to conduct the determination of the at least one characteristic of the secondary fuel when at least one of the engine and the driven device are operating at a predetermined condition and when at least one characteristic of the primary fuel is known.

3. The system of claim 1, wherein the driven device is an electric power generator, wherein the power output sensor is at least one of a voltage meter and a current meter.

4. The system of claim 1, wherein the primary fuel is diesel fuel and wherein the secondary fuel is natural gas.

5. The system of claim 4, wherein the at least one characteristic of the secondary fuel includes at least one of a gas heating value and a methane number.

6. The system of claim 1, wherein the electronic controller is further configured to determine an allowable substitution rate of the primary fuel with the secondary fuel based on the at least one characteristic of the secondary fuel.

7. The system of claim 1, wherein the electronic controller is further configured to determine a substitution rate difference between a measured substitution rate and an expected substitution rate of the primary fuel with the secondary fuel when the system is operating at a predetermined condition, the measured substitution rate being determined based on the primary and secondary fuel supply signals and the expected substitution rate being determined based on the power output signal, and wherein the at least one characteristic of the secondary fuel is determined based on the substitution rate difference.

8. The system of claim 1, wherein the electronic controller is further configured to determine at least one additional characteristic of the secondary fuel based on the at least one characteristic of the secondary fuel.

9. A method for determining at least one property of a secondary fuel used to substitute a portion of a primary fuel during operation of an internal combustion engine, the engine being connected to a generator, the method comprising:
operating the engine and the generator at a predetermined condition;
providing a flow of primary fuel having a known property to the engine;
measuring the flow of the primary fuel;
measuring an output of the generator;
measuring a flow of the secondary fuel; and
determining the at least one property of the secondary fuel based on the flow of primary fuel and the output of the generator.

10. The method of claim 9, wherein the primary fuel is diesel fuel, the secondary fuel is natural gas, the known property of the primary fuel is an expected substitution rate of diesel fuel with natural gas that produces an electrical power output that is measured at the output of the generator, and wherein the at least one property of the secondary fuel is based on a measured substitution rate.

11. The method of claim 10, wherein the at least one property of the secondary fuel is one of a gas heating value and a methane number.

12. The method of claim 9, further comprising operating the engine under an allowable substitution rate of primary fuel with secondary fuel, and adjusting the allowable substitution rate based on the at least one property of the secondary fuel.

13. The method of claim 9, wherein the predetermined condition is a condition in which the generator operates to provide a preselected power.

14. The method of claim 13, wherein the preselected power is present at the output of the generator during a calibration mode.

15. A dual fuel system for an engine having an engine output shaft connected to a power generator providing electrical power to a power grid, the dual fuel system comprising:
a primary fuel supply connected to the engine and including a primary fuel supply sensor, the primary fuel supply sensor configured to provide a primary fuel supply signal indicative of a rate of supply of a primary fuel to the engine through the primary fuel supply;
a secondary fuel supply connected to the engine and including a secondary fuel supply sensor, the secondary fuel supply sensor configured to provide a secondary fuel supply signal indicative of a rate of supply of a secondary fuel to the engine through the secondary fuel supply;
a power output sensor connected to a power output of the power generator, the power output sensor configured to measure the electrical power provided to the power grid and provide a power output signal;
an electronic controller operably associated with the engine and the power generator, the electronic controller disposed to receive the primary and secondary fuel supply signals and the power output signal,
wherein the electronic controller is configured to determine at least one characteristic of the secondary fuel based on the primary and secondary fuel supply signals and the power output signal.

16. The dual fuel system of claim 15, wherein the electronic controller is configured to conduct the determination of the at least one characteristic of the secondary fuel when at least one of the engine and the power generator are operating at a predetermined condition and when at least one characteristic of the primary fuel is known.

17. The dual fuel system of claim 15, wherein the power output sensor is at least one of a voltage meter and a current meter and wherein the primary fuel is diesel fuel and wherein the secondary fuel is natural gas.

18. The dual fuel system of claim 17, wherein the at least one characteristic of the secondary fuel includes at least one of a gas heating value and a methane number.

19. The dual fuel system of claim 15, wherein the electronic controller is further configured to determine an allowable substitution rate of the primary fuel with the secondary fuel based on the at least one characteristic of the secondary fuel, and wherein the electronic controller is configured to control one or more primary fuel valves associated with the primary fuel supply and a secondary fuel valve associated with the secondary fuel supply such that the engine operates using both the primary and secondary fuels at or below the allowable substitution rate.

20. The dual fuel system of claim 15, wherein the electronic controller is further configured to determine a substitution rate difference between a measured substitution rate and an expected substitution rate of primary fuel with secondary fuel when the engine and the power generator are operating at a predetermined condition, the measured substitution rate being determined based on the primary and secondary fuel supply signals and the expected substitution rate being determined based on the power output signal, and wherein the at least one characteristic of the secondary fuel is determined based on the substitution rate difference.
